(19) United States
(12) Patent Application Publication
(10) Pub. No.: US 2002/0181241 A1
(43) Pub. Date: Dec. 5, 2002

(54) Vehicle lamp

(75) Inventor: Martin Tietze, Eisenach (DE)

Correspondence Address: SUGHRUE MION, PLLC, 2100 Pennsylvania Avenue, N. W., Washington, DC, 20037-3213, US

(73) Assignee: FER Fahrzeugelektrik GmbH

(21) Appl. No.: 10/155,244

(22) Filed: May 28, 2002

(30) Foreign Application Priority Data
May 29, 2001 (DE) 201 08 982.3

(51) Int. Cl. B60Q 1/30

(52) U.S. Cl. 362/498; 362/494; 362/499; 362/507; 362/545; 362/547

(57) ABSTRACT

A vehicle lamp comprises at least one light source in the form of a light emitting diode. To improve dissipation of the waste heat generated in the series resistor the series resistor includes a flat resistor portion which can be so arranged that it is in areal heat-conducting contact with a portion of the vehicle to which the lamp is fitted.

### FIELD OF THE INVENTION

The invention concerns a vehicle lamp.

### BACKGROUND OF THE INVENTION

In relation to vehicle lamps there is an increasing trend for the incandescent lamps which have been used hitherto to be replaced by fight emitting diodes. In that respect, a plurality of light emitting diodes are always required for each lamp, particularly in the case of flashing lamps, tail lamps and the like, in order thereby to produce the light output values which are often required by statute, and the plurality of light emitting diodes in each lamp have to be switched on and off at the same time.

In recent times however light emitting diodes with higher levels of light output have become available, so that the number of light emitting diodes which are required for the respective lamp function to be performed and which therefore have to be simultaneously switched on and off within a lamp can be reduced.

The termination of that line of development may be that it will be possible to construct a complete lamp with only a single light emitting diode or possibly two light emitting diodes.

A basic problem in regard to using light emitting diodes however lies in the inherent heating effect of the semiconductor chip forming a fight emitting diode. It is necessary for that heat to be dissipated in a suitable manner in order not to exceed an upper limit temperature which is defined specifically in relation to the component involved, because otherwise a temperature in excess of the specified limit can result in a reduction in the level of light output, a shift in the light color and/or, in a worst case scenario, destruction of the light emitting diode.

A further difficulty in this respect is that the onboard voltage system of the motor vehicle, which is usually a 12 volt system, must be used to operate such light emitting diodes. That voltage however is substantially higher than the forward voltage in the case of a light emitting diode when it is switched on. It is therefore necessary to drop off the voltage difference at a dropping resistor connected in series with the light emitting diode.

If however only one or two light emitting diodes are to be used to provide for the lighting function of a vehicle lamp, it is then necessary to use an additional non-lighting resistor. As the light emitting diodes which are usual nowadays and which light up markedly more brightly require very high operating currents, a correspondingly high power is converted into heat at such resistors. That not only results in such resistors being of considerable size, but it also necessitates additional measures being taken as it is necessary to ensure that the heat generated at the resistor does not additionally heat up the temperature-sensitive semiconductor chip.

### SUMMARY OF THE INVENTION

An object of the present invention is to design a vehicle lamp in such a way that it uses the smallest possible number of light emitting diodes for the respective lighting function it is to perform, more particularly a single light emitting diode.

Another object of the present invention is to provide a vehicle lamp with a light emitting diode as its light source and a series resistor, such that the heat generated by the resistor can be dissipated to prevent unacceptable overheating.

Still another object of the present invention is to provide a vehicle lamp using a light emitting diode as its light source, which is of a simple design configuration while ensuring that a rise in temperature in the light emitting diode circuitry can be acceptably prevented.

Yet another object of the present invention is to provide a vehicle lamp including a light emitting diode and a resistor in series therewith, which is so designed that it can share component parts with other functional units of a vehicle to which the lamp is fitted.

In accordance with the invention the foregoing and other objects are attained by a vehicle lamp comprising at least one light source in the form of a light emitting diode. The lamp has at least one dropping resistor connected in series with the light emitting diode. The resistor includes a flat or areal resistor portion which can be arranged in such a fashion that it is in flat or areal, heat-conducting contact with a part of the vehicle to which the lamp is fitted.

As will be seen in greater detail from the description hereinafter of preferred embodiments of the invention, the fact that the series resistor is of a flat or areal configuration means that it can be of a very small thickness so that it can advantageously be used wherever a small structural height is required in that respect. Because it is in heat-conducting contact with any suitable part of the motor vehicle to which the lamp is fitted, it is possible for the waste heat generated by the resistor to be dissipated in such a way that the heat-sensitive semiconductor chip of the light emitting diode does not experience an additional heating effect.

In principle it is possible for only a part of the series resistor of the light emitting diode to be of a flat form and for it to be connected in series with a second resistor of usual configuration. In a preferred feature however the entire series resistor is in the form of a flat or areal resistor.

An embodiment which is particularly inexpensive and simple to produce provides that the flat resistor is in the form of a film which is provided with a resistance layer and which is preferably self-adhesive. Accordingly, the film can be readily adhered to any suitable part of the vehicle, in a suitable position and being of suitable size, thereby automatically providing the flat, heat-conducting contact required between the resistor and the part of the vehicle.

The heat generated by the resistor connected in series with the light emitting diode can be used in a particularly advantageous fashion if, in the installed condition, it is in heat-conducting contact with a part of the vehicle which is to be heated at least under certain operation conditions, for example in winter. This part of the vehicle in question may be for example a part of the vehicle lamp itself or another part of the vehicle, which is in the proximity of the lamp.

A particularly preferred feature of the invention provides that the lamp is fitted for example in the form of a flashing lamp in an external rear view mirror of a motor vehicle. In that case the resistor connected in series with the at least one light emitting diode is either secured as by adhesive into the interior of the mirror cap or casing or on the rear side of the mirror glass in order to heat same in addition to a rear view mirror heating system which may often be provided as a matter of course.

In quite general terms however there is no necessity for the resistor which is connected in series with the light emitting diode to be mounted in the immediate proximity of the latter. Rather, it can be disposed at any suitable point in the vehicle and connected to the light emitting diode by way of an appropriate line. In that respect, the series resistor will preferably always be disposed at a location at which the heat generated thereby does not cause damage or at a position at which its generated heat is wanted in a particularly preferable situation for a heating effect.

Further objects, features and advantages of the invention will be apparent from the description hereinafter of preferred embodiments of the invention.

### BRIEF DESCRIPTION OF THE DRAWING

FIG. 1 is a highly diagrammatic view of a light emitting diode of a vehicle lamp with a flat series resistor,

FIG. 2 shows a front view of a mirror glass of a motor vehicle external rear view mirror, and

FIG. 3 is a view in section through the mirror glass of FIG. 2 taken along line III-III with associated circuitry.

### DESCRIPTION OF PREFERRED EMBODIMENTS

It will first be noted that the same components are denoted in the various Figures of the drawing by the same references.

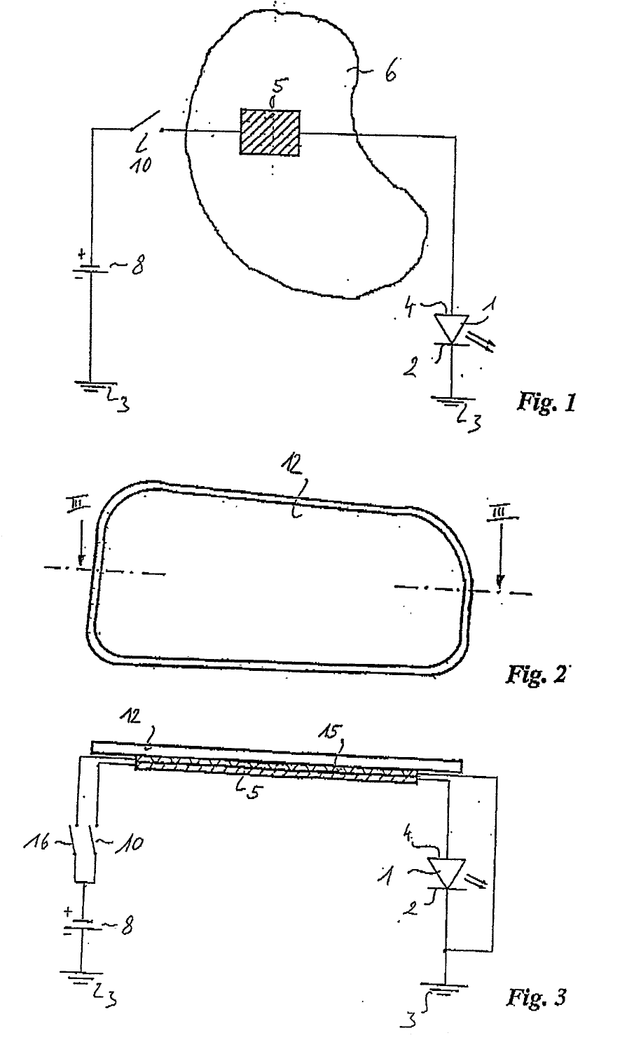

Looking firstly at FIG. 1, reference numeral 1 indicates a light emitting diode forming a light source of a vehicle lamp, the other component parts of which are not shown herein for the sake of simplicity.

The light emitting diode 1 has its cathode 2 connected to ground 3 formed by the vehicle bodywork. Reference numeral 4 denotes the anode of the light emitting diode 1, which is connected to a flat or areal series resistor 5 formed by a portion of a self-adhesive film which has a resistance layer thereon. The film is fixed by adhesive to a diagrammatically indicated portion 6 of the motor vehicle body. If for example the vehicle lamp is a side flashing lamp which is incorporated in the external rear view mirror of the motor vehicle, the body portion 6 may be the cap or cover of the mirror casing. In principle however the series resistor 5 can be disposed in intimate contact with any other substantially flat part of the vehicle body. It will be noted in this respect that the important consideration here is that the body portion 6 is suitable for dissipating the waste heat generated in operation of the light emitting diode 1 in the series resistor 5, without a detrimental effect on any other part of the motor vehicle.

So that the light emitting diode 1 can be appropriately switched on and off, the line (shown but not referenced in FIG. 1) which connects the series resistor 5 and a battery 8 includes a switch 10. The switch 10 is shown in the form of a mechanical contact switch but it can also be embodied in the form of an electronic switch which can be suitably opened or closed by appropriate control signals or which, in the case of a side flashing lamp, can be actuated in a pulsating manner to produce the flashing effect at the light emitting diode 1.

Reference will now be made to FIGS. 2 and 3 diagrammatically showing use of the flat series resistor 5 as an additional heating means for a mirror glass 12 of a motor vehicle external rear view mirror, As can be seen from FIG. 3 in particular, a first flat heating resistor 15 is fixed by adhesive on the rear side of the mirror glass 12. The heating resistor 15 can be activated by means of a suitable control switch 16, independently of operation of the light emitting diode 1, and thus makes it possible to provide for heating of the mirror glass 12, even if the side flashing lamp which includes the light emitting diode 1 as its light source is not in operation.

In addition, on its side remote from the rear surface of the mirror glass 12, the flat heating resistor 15 carries the flat series resistor 5 which is connected in series with the light emitting diode 1 and which, just as is shown in FIG. 1, can be appropriately actuated by operation of the switch 10.

It will be noted that it is important in this arrangement that the two switches 10 and 16 can be actuated completely independently of each other.

It will be seen from the foregoing description that the resistor connected in series with the at least one light emitting diode forming the light source of the vehicle lamp includes a flat resistor portion which is so arranged that it is in flat, heat-conducting contact with a part of the motor vehicle, as indicated at 6 in FIG. 1 and at 12 in FIGS. 2 and 3. The entire series resistor may be in the form of the flat resistor to provide the optimum effect in that respect.

It will be appreciated that the above-described embodiments of the invention have been set forth solely by way of example and illustration of the principles thereof and that various other modifications and alterations may be made therein without thereby departing from the spirit and scope of the invention.

What is claimed is:

1. A vehicle lamp comprising
at least one light source in the form of a light emitting diode, and
at least one resistor in series with the light emitting diode,
wherein the series resistor includes a flat resistor portion adapted to be so arranged that it is in flat heat-conducting contact with a portion of the vehicle on which in use the lamp is fitted.

2. A lamp as set forth in claim 1
wherein the entire series resistor is in the form of a flat resistor.

3. A lamp as set forth in claim 1
wherein the flat resistor portion is in the form of a film provided with a resistance layer.

4. A lamp as set forth in claim 3
wherein said film is self-adhesive.

5. A lamp as set forth in claim 1
wherein said flat resistor portion is in flat heat-conducting contact with a portion of the vehicle which is to be heated at least under some operating conditions.

6. A lamp as set forth in claim 1
wherein the portion of the vehicle with which said flat resistor portion is in heat-conducting contact is a portion of the lamp itself.

7. A lamp as set forth in claim 1
wherein the portion of the vehicle with which the flat resistor portion is in heat-conducting contact is a mirror glass of a motor vehicle external rear view mirror in which the lamp is installed.

8. A lamp as set forth in claim 7
wherein the external rear view mirror includes heating means and wherein said heating means serves at the same time as said resistor portion for the at least one light emitting diode.

9. A lamp as set forth in claim 7
wherein the external rear view mirror includes heating means and wherein said heating means includes an additional resistance region serving as said resistor portion for the at least one light emitting diode.

10. A lamp as set forth in claim 1
wherein said portion of the vehicle is the mirror cap of a motor vehicle external rear view mirror in which the lamp is installed.

11. A lamp as set forth in claim 7
which is installed in the external rear view mirror as a flashing lamp.
